(19) United States
(12) Patent Application Publication
(10) Pub. No.: US 2018/0343694 A1
(43) Pub. Date: Nov. 29, 2018

(54) BASE STATION, TERMINAL APPARATUS, METHOD

(71) Applicant: NEC CORPORATION, Tokyo (JP)

(72) Inventor: Kazunari TOMISHIGE, Tokyo (JP)

(73) Assignee: NEC CORPORATION, Tokyo (JP)

(21) Appl. No.: 15/962,240

(22) Filed: Apr. 25, 2018

(30) Foreign Application Priority Data
May 23, 2017 (JP) 2017-101555

(51) Int. Cl. H04W 76/15; H04W 28/06

(52) U.S. Cl. CPC H04W 76/15; H04W 88/08; H04W 28/06

(57) ABSTRACT

To ensure, in an environment where plurality of services are provided to a terminal apparatus through a radio communication network, stable communication of the radio communication network with respect to a certain service. A base station 100 includes: an acquisition unit 141 configured to acquire an identifier used to newly establish, in a state where plurality of services are provided by using a first radio bearer, a second radio bearer for at least one first service among the plurality of services; and a transmit processing unit 143 configured to transmit the identifier to a terminal apparatus 200.

### BACKGROUND

### Technical Field

The present disclosure relates to a base station, a terminal apparatus, and a method.

The present application claims priority based on Japanese Patent Application No. 2017-101555, filed on May 23, 2017, the contents of which are incorporated herein by reference.

### Background Art

For services using the mobile edge computing (MEC) technology or the like, packet loss may be fatal to service operation in some cases. For example, in a mission critical service such as a financial service, a server, for example, needs to constantly monitor the state of each terminal apparatus by regularly communicating with the terminal apparatus, to avoid any risks. Hence, in mission critical services, if packet loss occurs in the radio section between a base station and a terminal apparatus, this may cause a fatal risk in service operation.

In view of this, for services such as the above-described mission critical services, it is necessary to reduce packet loss in the radio section by employing a special scheduling method, to avoid the occurrence of packet loss.

For example, WO 2016/132429 (PTL 1) describes a technique for setting relay nodes and base stations serving as additional path candidates, in order to add, to an existing path, an additional path candidate satisfying predetermined communication quality.

[PTL 1] WO 2016/132429

### SUMMARY

In the technique disclosed in PTL 1, however, it is not considered how to configure a radio bearer. For example, packet loss may be reduced by employing scheduling for allocating lots of radio resources for all the services provided by using each of the radio bearers configured for a particular terminal apparatus (UE).

However, employing the above-described special scheduling for all the services may cause a waste of radio resources, which may affect services provided to terminal apparatuses of other users.

An example object of the present invention is to provide a base station, a terminal apparatus, and a method that make it possible to ensure, in an environment where plurality of services are provided to a terminal apparatus through a radio communication network, stable communication of the radio communication network with respect to a certain service.

According an example aspect of the present invention, a base station comprises: a memory storing a program; and one or more processors configured to execute the program to: acquire an identifier used to newly establish, in a state where plurality of services are provided by using a first radio bearer, a second radio bearer for at least one first service among the plurality of services; and transmit the identifier to a terminal apparatus.

According an example aspect of the present invention, a terminal apparatus comprises a memory storing a program; and one or more processors configured to execute the program to: receive, from a base station, an identifier used to newly establish, in a state where plurality of services are provided by using a first radio bearer, a second radio bearer for at least one first service among the plurality of services; and execute processing relating to the first service, by using the identifier.

According an example aspect of the present invention, a method includes: acquiring an identifier used to newly establish, in a state where plurality of services are provided by using a first radio bearer, a second radio bearer for at least one first service among the plurality of services; and transmitting the identifier to a terminal apparatus.

According to the present invention, it is possible to ensure, in an environment where plurality of services are provided to a terminal apparatus through a radio communication network, stable communication of the radio communication network with respect to a certain service. Note that the present invention may exert other advantageous effects instead of the above advantageous effects or together with the above advantageous effects.

### BRIEF DESCRIPTION OF DRAWINGS

FIG. 1 is an explanatory diagram illustrating an example of a schematic configuration of a system according to example embodiments of the present invention.

FIG. 2 is an explanatory diagram illustrating an example of a schematic configuration of a base station according to a first example embodiment of the present invention.

FIG. 3 is an explanatory diagram illustrating an example of a schematic configuration of a terminal apparatus according to the first example embodiment of the present invention.

FIG. 4 is a flowchart illustrating a schematic flow of a first operation example according to the first example embodiment.

FIG. 5 is a diagram for describing a schematic configuration of a mission critical (MC) dedicated radio bearer (DRB).

FIG. 6 is a diagram for describing an example of a schematic configuration of MC config IE.

FIG. 7 is a flowchart illustrating a schematic flow of a second operation example according to the first example embodiment.

FIG. 8 is an explanatory diagram illustrating an example of a schematic configuration of a base station according to a second example embodiment of the present invention.

FIG. 9 is an explanatory diagram illustrating an example of a schematic configuration of a terminal apparatus according to the second example embodiment of the present invention.

### DESCRIPTION OF THE EXAMPLE EMBODIMENTS

Details of example embodiments of the present invention will be described below with reference to the accompanying drawings. Note that, in the present description and drawings, elements to which the same or similar descriptions are applicable are denoted by the same reference signs, whereby overlapping descriptions may be omitted.

Descriptions will be given in the following order.

1. Overview of Example Embodiments of the Present Invention

2. Configuration of System

3. First Example Embodiment
3.1. Configuration of Base Station
3.2. Configuration of Terminal Apparatus
3.3. Technical Features
3.4. Operation Examples
3.5. Effects

4. Second Example Embodiment
4.1. Configuration of Base Station
4.2. Configuration of Terminal Apparatus
4.3. Technical Features

5. Other Modes

### 1. Overview of Example Embodiments of the Present Invention

First, an overview of example embodiments of the present invention is described.

### (1) Technical Problem

For services using the mobile edge computing (MEC) technology or the like, packet loss may be fatal to service operation in some cases. For example, in a service for mission critical business such as a financial service, a server needs to constantly monitor the state of each terminal apparatus by regularly communicating with the terminal apparatus in order to avoid any risk. In other words, in such services, if packet loss occurs in the radio section between a base station and a terminal apparatus, this may cause a fatal risk in service operation.

In view of this, for such services, it is necessary to reduce packet loss in the radio section by employing a special scheduling method, to avoid the occurrence of packet loss.

For example, packet loss may be reduced by employing scheduling for allocating lots of radio resources for all the services provided by using each of the radio bearers configured for a particular terminal apparatus (UE).

However, employing the above-described special scheduling for all the services may cause a waste of radio resources, which may affect services provided to terminal apparatuses of other users.

In particular, in a case of an operation mode where plurality of services are mapped to a certain service class in a congested state of radio communication, the amount of data transmission of other users is reduced. Thus, a waste of radio resources greatly affects user services in a cell.

Meanwhile, if there is a method of identifying only a particular service in a LTE protocol and applying a special scheduling method only to the traffic of the particular service, a waste of radio resources may be prevented. However, since there is no such method, it is difficult to apply the special scheduling method only to a certain service.

An example object of the example embodiments of the present invention is to ensure, in an environment where plurality of services are provided to a terminal apparatus through a radio communication network, stable communication of the radio communication network with respect to a certain service.

### (2) Technical Features

In the example embodiments of the present invention, for example, a base station acquires an identifier used to newly establish, in a state where plurality of services are provided by using a first radio bearer, a second radio bearer for at least one first service among the plurality of services, and transmits the identifier to a terminal apparatus.

Moreover, in the example embodiments of the present invention, for example, a terminal apparatus receives, from a base station, an identifier used to newly establish, in a state where plurality of services are provided by using a first radio bearer, a second radio bearer for one or more first service among the plurality of services, and performs processing relating to the at least one first service by using the identifier.

This makes it possible, for example, to ensure, in an environment where plurality of services are provided to a terminal apparatus through a radio communication network, stable communication of the radio communication network with respect to a certain service.

Note that the above-described technical features are concrete examples of the example embodiments of the present invention, and example embodiments of the present invention are, of course, not limited to the above-described technical features.

### 2. Configuration of System

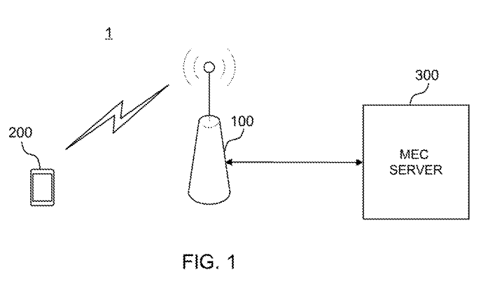

With reference to FIG. 1, an example of a configuration of a system 1 according to the example embodiments of the present invention is described. FIG. 1 is an explanatory diagram illustrating an example of a schematic configuration of the system 1 according to the example embodiments of the present invention. With reference to FIG. 1, the system 1 includes a base station 100, a terminal apparatus 200, and a MEC server 300.

For example, the system 1 is a system conforming to standards/specifications of the Third Generation Partnership Project (3GPP). More concretely, for example, the system 1 may be a system conforming to standards/specifications of the LTE/LTE-Advanced and/or the system architecture evolution (SAE). Alternatively, the system 1 may be a system conforming to fifth generation (5G)/new radio (NR) standards/specifications. The system 1 is, of course, not limited to these examples.

### (1) Base Station 100

The base station 100 is a radio access network (RAN) node and performs radio communication with a terminal apparatus (e.g., the terminal apparatus 200) located in the coverage area of the base station 100.

For example, the base station 100 may be an evolved Node B (eNB) or may be a generation Node B (gNB) in 5G. The base station 100 may include plurality of units (or plurality of nodes). The plurality of units (or plurality of nodes) may include a first unit (or first node) configured to perform higher protocol layer processing and a second unit (or second node) configured to perform lower protocol layer processing. As an example, the first unit may be referred to as a center/central unit (CU), and the second unit may be referred to as a distributed unit (DU) or an access unit (AU). As another example, the first unit may be referred to as a digital unit (DU), and the second unit may be referred to as a radio unit (RU) or a remote unit (RU). The digital unit (DU) may be a base band unit (BBU, baseband unit), and the RU may be a remote radio head (RRH) or a remote radio unit (RRU). Terms used to refer to the first unit (or first node) and the second unit (or second node) are, of course, not limited to these examples. Alternatively, the base station 100 may be a single unit (or single node). In this case, the base station 100 may be one unit in the plurality of units (e.g., one of the first unit and the second unit) and may be connected to another one unit in the plurality of units (e.g., the other one of the first unit and the second unit).

### (2) Terminal Apparatus 200

The terminal apparatus 200 performs radio communication with a base station. For example, when the terminal apparatus 200 is located in the coverage area of the base station 100, the terminal apparatus 200 performs radio communication with the base station 100. For example, the terminal apparatus 200 is a user equipment (UE).

### (3) MEC Server 300

The MEC server 300 is installed in the radio access network so as to be able to communicate directly with the base station 100 (i.e., without passing through a core network). For example, the MEC server 300 may be installed in the same building as that where the base station 100 is located, and connected to a local area network in this site so as to be able to communicate with the base station 100.

In addition, the MEC server 300 includes computing resources for edge computing relating to services or applications for a terminal apparatus (e.g., the terminal apparatus 200), and storage resources.

### 3. First Example Embodiment

Next, a first example embodiment of the present invention is described.

### 3.1. Configuration of Base Station

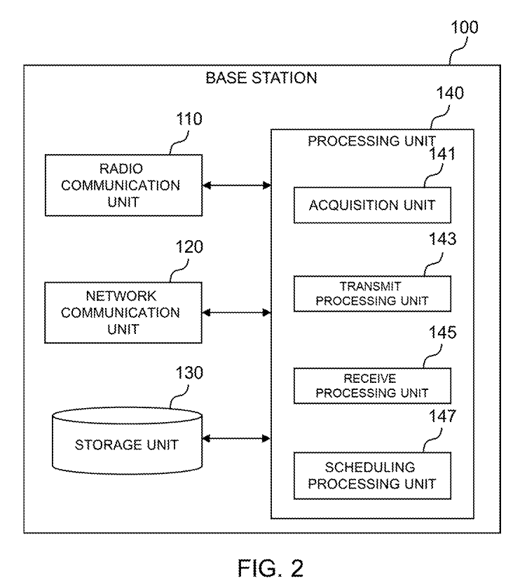

With reference to FIG. 2, an example of a configuration of a base station 100 according to the first example embodiment is described. FIG. 2 is a block diagram illustrating an example of a schematic configuration of the base station 100 according to the first example embodiment. With reference to FIG. 2, the base station 100 includes a radio communication unit 110, a network communication unit 120, a storage unit 130, and a processing unit 140.

### (1) Radio Communication Unit 110

The radio communication unit 110 transmits and/or receives signals wirelessly. For example, the radio communication unit 110 receives a signal from a terminal apparatus and transmits a signal to a terminal apparatus.

### (2) Network Communication Unit 120

The network communication unit 120 receives a signal from a network and transmits a signal to a network.

### (3) Storage Unit 130

The storage unit 130 temporarily or permanently stores programs (instructions) and parameters for operations of the base station 100 as well as various data. The programs each include one or more instructions for operations of the base station 100.

### (4) Processing Unit 140

The processing unit 140 provides various functions of the base station 100. The processing unit 140 includes an acquisition unit 141, a transmit processing unit 143, a receive processing unit 145, and a scheduling processing unit 147. Note that the processing unit 140 may further include other constituent components than these constituent components. In other words, the processing unit 140 may perform other operations than the operations of these constituent components. Concrete operations of the acquisition unit 141, the transmit processing unit 143, the receive processing unit 145, and the scheduling processing unit 147 will be described later in detail.

For example, the processing unit 140 (transmit processing unit 143 and receive processing unit 145) communicates with a terminal apparatus (e.g., the terminal apparatus 200) via the radio communication unit 110. For example, the processing unit 140 communicates with another network node (e.g., the MEC server 300 or a core network node) via the network communication unit 120.

### (5) Implementation Examples

The radio communication unit 110 may be implemented by an antenna, a radio frequency (RF) circuit, and the like, and the antenna may be a directional antenna. The network communication unit 120 may be implemented by a network adapter and/or a network interface card, and the like. The storage unit 130 may be implemented by a memory (e.g., a nonvolatile memory and/or a volatile memory) and/or a hard disk, and the like. The processing unit 140 may be implemented by one or more processors, such as a baseband (BB) processor and/or a processor of another kind. The acquisition unit 141, the transmit processing unit 143, the receive processing unit 145, and the scheduling processing unit 147 may be implemented by the same processor or may be implemented individually by different processors. The memory (storage unit 130) may be included in the one or more processors or may be provided outside the one or more processors.

The base station 100 may include a memory storing programs (instructions) and one or more processors that can execute the programs (instructions). The one or more processors may execute the programs to perform operations of the processing unit 140 (operations of the acquisition unit 141, the transmit processing unit 143, the receive processing unit 145, and/or the scheduling processing unit 147). The programs may be programs for causing the processor(s) to perform operations of the processing unit 140 (operations of the acquisition unit 141, the transmit processing unit 143, the receive processing unit 145, and/or the scheduling processing unit 147).

Note that the base station 100 may be virtualized. In other words, the base station 100 may be implemented as a virtual machine. In this case, the base station 100 (virtual machine) may operate as a physical machine (hardware) including a processor, a memory, and the like, and a virtual machine on a hyperbizer.

### 3.2. Configuration of Terminal Apparatus

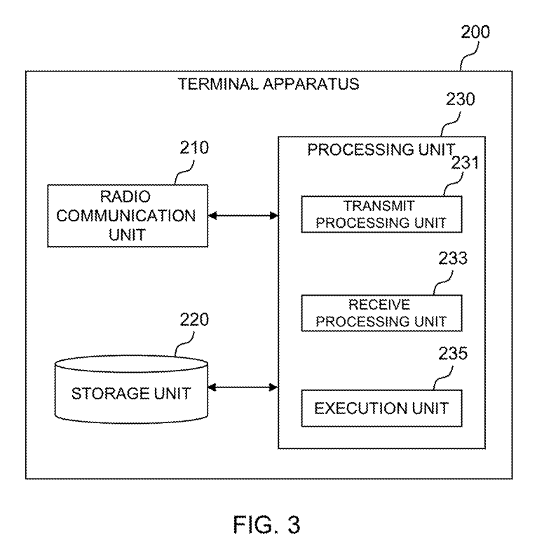

With reference to FIG. 3, an example of a configuration of the terminal apparatus 200 according to the first example embodiment is described. FIG. 3 is a block diagram illustrating an example of a schematic configuration of the terminal apparatus 200 according to the first example embodiment. With reference to FIG. 3, the terminal apparatus 200 includes a radio communication unit 210, a storage unit 220, and a processing unit 230.

### (1) Radio Communication Unit 210

The radio communication unit 210 transmits and/or receives signals wirelessly. For example, the radio communication unit 210 receives a signal from a base station and transmits a signal to a base station.

### (2) Storage Unit 220

The storage unit 220 temporarily or permanently stores programs (instructions) and parameters for operations of the terminal apparatus 200 as well as various data. The programs each include one or more instructions for operations of the terminal apparatus 200.

### (3) Processing Unit 230

The processing unit 230 provides various functions of the terminal apparatus 200. The processing unit 230 includes a transmit processing unit 231, a receive processing unit 233, and an execution unit 235. Note that the processing unit 230 may further include other constituent components than these constituent components. In other words, the processing unit 230 may perform other operations than the operations of these constituent components. Concrete operations of the transmit processing unit 231, the receive processing unit 233, and the execution unit 235 will be described later in detail.

For example, the processing unit 230 (transmit processing unit 231 and receive processing unit 233) communicates with a base station (e.g., the base station 100) via the radio communication unit 210.

### (4) Implementation Examples

The radio communication unit 210 may be implemented by an antenna, a radio frequency (RF) circuit, and the like. The storage unit 220 may be implemented by a memory (e.g., a nonvolatile memory and/or a volatile memory) and/or a hard disk, and the like. The processing unit 230 may be implemented by one or more processors, such as a baseband (BB) processor and/or a processor of another kind. The transmit processing unit 231, the receive processing unit 233, and the execution unit 235 may be implemented by the same processor or may be implemented individually by different processors. The memory (storage unit 220) may be included in the one or more processors or may be provided outside the one or more processors. As an example, the processing unit 230 may be implemented in a system on chip (SoC).

The terminal apparatus 200 may include a memory storing programs (instructions) and one or more processors that can execute the programs (instructions). The one or more processors may execute the programs to perform operations of the processing unit 230 (the operations of the transmit processing unit 231, the receive processing unit 233, and/or the execution unit 235). The programs may be programs for causing the processor(s) to perform operations of the processing unit 230 (the operations of the transmit processing unit 231, the receive processing unit 233, and/or the execution unit 235).

### 3.3. Technical Features

Next, technical features of the first example embodiment are described.

The base station 100 (acquisition unit 141) acquires an identifier used to newly establish, in a state where plurality of services are provided by using a first radio bearer, a second radio bearer for at least one first service among the plurality of services. In other words, the base station 100 (acquisition unit 141) acquires the identifier used to newly establish the second radio bearer for the one or more first services among the plurality of services, the plurality of services being provided by the first bearer. The base station 100 (transmit processing unit 143) then transmits the identifier to the terminal apparatus 200.

Moreover, the terminal apparatus 200 (receive processing unit 233) receives the identifier from the base station 100. The terminal apparatus 200 (execution unit 235) then executes processing relating to the first service, by using the identifier.

### (1) First Service(s)

The first service is a mission critical service(s). Specifically, the first service is, for example, a service provided to the terminal apparatus 200 by the MEC server 300 via the base station 100.

### (2) Identifier

The identifier is a radio network temporary identifier (RNTI). Specifically, the identifier is a mission critical RNTI (also referred to as a MC-RNTI below). The MC-RNTI is a RNTI different from a RNTI used for communication by the first radio bearer, i.e., a new RNTI configured by the base station 100 to establish the second radio bearer.

### (3) Acquisition of Identifier

The base station 100 (acquisition unit 141) acquires the identifier by configuring the identifier on the basis of identification information for identifying the terminal apparatus 200 using the first service. Here, the identification information is notified by a server (e.g., the MEC server 300) managing the first service. For example, as the identification information, an identifier for the MEC server 300 to identify each user using the first service, such as a tunnel endpoint identity (TEID), a mission critical (MC)-UEID, a Dst Port, or a Dst IP address.

Notification Timing for Identification Information

The base station 100 may be notified of the identification information when the server (e.g., the MEC server 300) determines to be impossible to maintain operation of the first service. Alternatively, the terminal apparatus 200 may be notified of the identification information by the server (e.g., the MEC server 300) at the time of starting operation of the first service.

### (4) Transmission and/or Reception of Control Information Relating to Header Compression

The base station 100 (transmit processing unit 143) may transmit, to the terminal apparatus 200, control information relating to header compression for packets for the first service, in addition to the identifier. Here, the control information relating to the header compression is, for example, profile information for robust header compression (ROHC) calculated from the protocol type of the first service.

### (5) Scheduling Processing

The terminal apparatus 200 (execution unit 235) requests the base station 100 to perform scheduling relating to the second radio bearer for the first service, by using the identifier.

Meanwhile, the base station 100 (scheduling processing unit 147) performs the scheduling relating to the second radio bearer, on the basis of the control information relating to header compression for the packets for the first service. A concrete example of the flow of the scheduling processing will be described later.

### 3.4. Operation Example

Next, an operation example of processing performed in the system 1 is described.

### First Operation Example

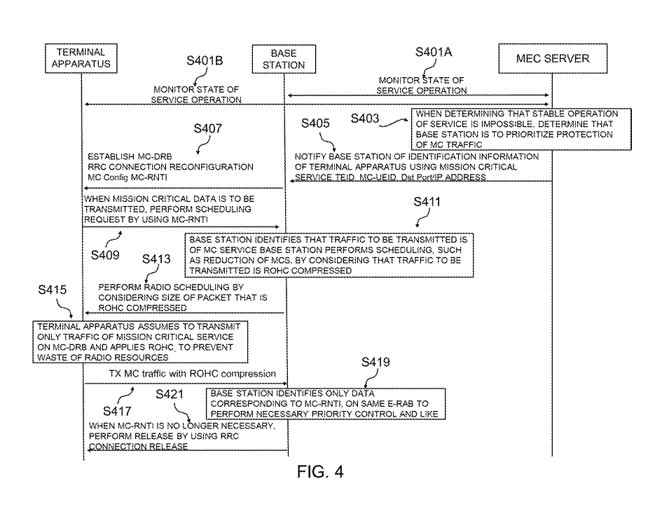

First, processing according to a first concrete example is described with reference to FIG. 4.

In Step S401A and Step S401B, the MEC server 300 accesses each of the base station 100 and the terminal apparatus 200 to monitor the state of operation of a mission critical service. For example, upon detection of a congested state of radio communication or the like by the base station 100 under the environment where plurality of communications of different traffic types exist, the MEC server 300 is notified of the detected information as information relating to the state of operation of the monitoring target. The processing thereafter advances to Step S403.

In Step S403, when the MEC server 300 determines, on the basis of the state of operation of the mission critical service, that stable operation of the service is impossible, the MEC server 300 determines to prioritize protection of traffic for the mission critical service. The processing thereafter advances to Step S405.

In Step S405, the MEC server 300 notifies the base station 100 of TEID, mission critical (MC)-UEID, Dst Port, and Dst IP address as identification information for identifying the terminal apparatus using the mission critical service (e.g., the terminal apparatus 200). The processing thereafter advances to Step S407.

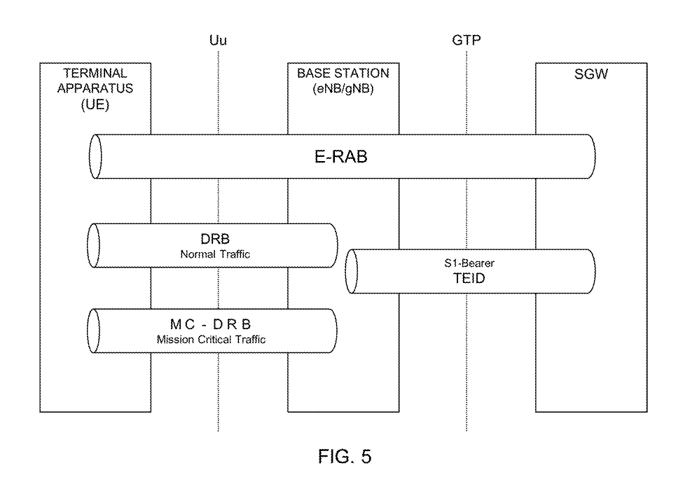

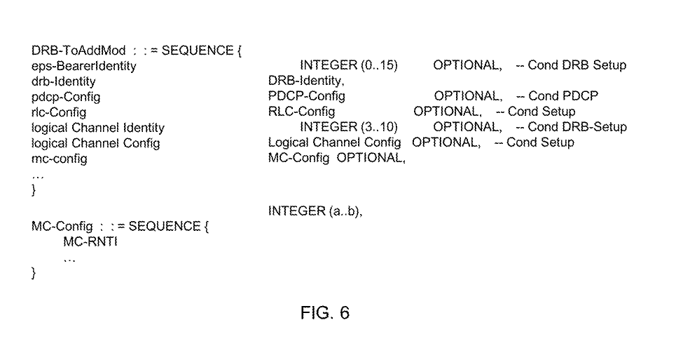

In Step S407, as illustrated in FIG. 5, for example, the base station 100 establishes a new bearer between the base station 100 and the terminal apparatus 200, specifically, establishes a mission critical dedicated radio bearer (MC-DRB) for mission critical traffic. Concretely, the base station 100 notifies the terminal apparatus 200 of information relating to the ROHC profile calculated from the protocol type of the service being used (mission critical service), and a MC-RNTI. The MC-RNTI may be notified from the base station 100 to the terminal apparatus 200 by using a message as the following one, for example. Specifically, the MC-RNTI may be notified from the base station 100 to the terminal apparatus 200 by defining MC config IE as that illustrated in FIG. 6, for example, in RadioResourceConfigDedicated IE specified in 3GPP TS 36.331 V14.2.2. The processing thereafter advances to Step S409.

In Step S409, at the time of transmitting traffic data relating to the mission critical service to the base station 100 in uplink, the terminal apparatus 200 applies the ROHC to the traffic data and makes a scheduling request to the base station 100 by using the MC-RNTI. The processing thereafter advances to Step S411.

In Step S411 and Step S413, the base station 100 identifies that the traffic data transmitted from the terminal apparatus 200 is of the mission critical service and performs scheduling based on the identification. Concretely, the base station 100 performs scheduling in consideration that the traffic data to be transmitted from the terminal apparatus 200 is ROHC compressed. Specifically, the base station 100 performs radio scheduling such as reduction in coding rate in consideration of the size of user data payload that is ROHC compressed. Such scheduling can reduce packet loss. Moreover, since individual DRBs are established, ROHC can be applied only to the MC-DRB to which the mission critical service is mapped.

In Step S415 and Step S417, the terminal apparatus 200 transmits only the traffic data of the mission critical service by using the MC-DRB. Through this operation, the terminal apparatus 200 can reduce radio resource consumption by applying the ROHC to the traffic data of the mission critical service. The processing thereafter advances to Step S419.

In Step S419, the base station 100 performs necessary priority control and the like by identifying, on the E-UTRAN radio access bearer (E-RAB), data on the MC-DRB established by using the MC-RNTI. Specifically, since the base station 100 can identify the traffic data of the mission critical service on the E-RAB, the base station 100 can apply priority control according to the priority level only to the traffic data of the mission critical service. The processing thereafter advances to Step S421.

In Step S421, when the MC-RNTI is no longer necessary because the congestion is solved, the service is released, or the like, the base station 100 releases the MC-DRB by using RRC CONNECTION RELEASE, for example, and terminates the processing illustrated in FIG. 4.

### Second Operation Example

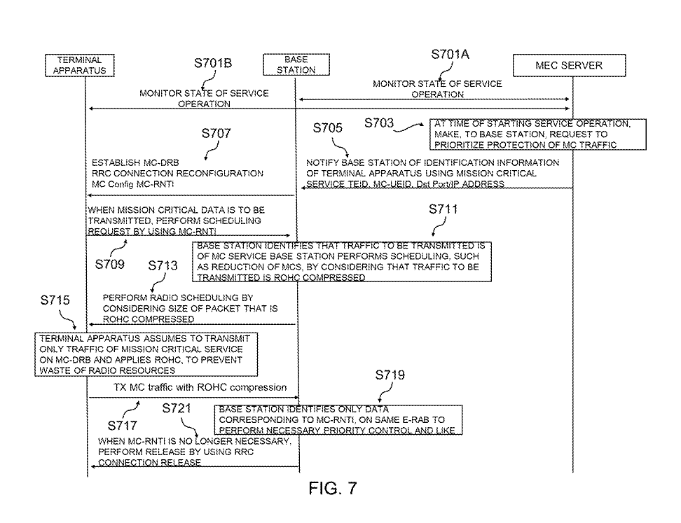

Next, processing according to a second concrete example is described with reference to FIG. 7.

In Step S701A and Step S701B, the MEC server 300 accesses each of the base station 100 and the terminal apparatus 200 to monitor the state of operation of a mission critical service. The processing thereafter advances to Step S703.

In Step S703, upon detection that operation of the mission critical service is started, the MEC server 300 determines to prioritize protection of traffic for the mission critical service. The processing in Step S705 to Step S721 is thereafter performed. Here, since Step S705 to Step S721 are similar to Step S405 to Step S421 described above, descriptions thereof are omitted.

### Other Operation Examples

For example, bearers to which the terminal apparatus 200 has mapped traffic data for a mission critical service may be collected without establishing any MC-DRB as in the first and second operation examples. In this case, prioritized scheduling may be applied to the bearers.

The operations are also applicable to a case of transmitting traffic data of a mission critical service in downlink. Specifically, the base station 100 may apply the ROHC to traffic data of a mission critical service in downlink. Concretely, the base station 100 performs scheduling such as reduction in coding rate in consideration of the size of user data payload that is ROHC compressed, whereby packet loss can be reduced in downlink.

### 3.5. Effects

The first example embodiment has been described above. According to the first example embodiment, it is possible to ensure, in an environment where plurality of services are provided to a terminal apparatus through a radio communication network, stable communication of the radio communication network with respect to a certain service.

In particular, according to the first example embodiment, definition of information for identifying a mission critical service is established, and the base station 100 side can provide a mechanism for reducing a packet loss rate for traffic for the mission critical service. In other words, it is possible to efficiently reduce packet loss by focusing only on traffic of a mission critical service without wasting radio resources, to thereby enable stable operation of the service.

### 4. Second Example Embodiment

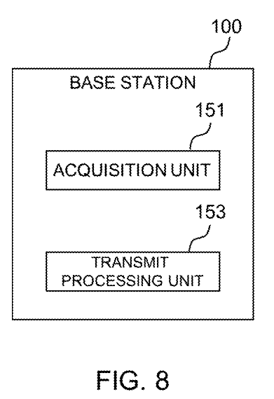

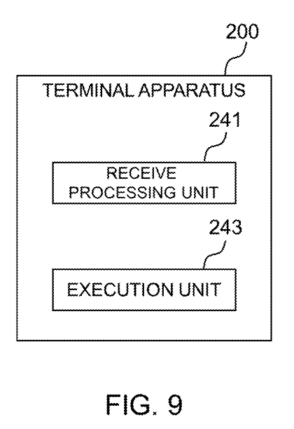

Next, with reference to FIG. 8 and FIG. 9, a second example embodiment of the present invention is described. The above-described first example embodiment is a concrete example embodiment, whereas the second example embodiment is a more generalized example embodiment.

### 4.1. Configuration of Base Station

First, with reference to FIG. 8, an example of a configuration of a base station (base station 100) according to the second example embodiment is described. FIG. 8 is a block diagram illustrating an example of a schematic configuration of the base station 100 according to the second example embodiment. With reference to FIG. 8, the base station 100 includes an acquisition unit 151 and a transmit processing unit 153. Concrete operations of the acquisition unit 151 and the transmit processing unit 153 will be described later.

The acquisition unit 151 and the transmit processing unit 153 may be implemented by the same processor or may be implemented individually by different processors. The acquisition unit 151 and the transmit processing unit 153 may include a memory storing programs (instructions) and one or more processors that can execute the programs (instructions), and the one or more processors may perform operations of the acquisition unit 151 and the transmit processing unit 153. The programs may be programs for causing the processor(s) to perform operations of the acquisition unit 151 and the transmit processing unit 153.

### 4.2. Configuration of Terminal Apparatus

First, with reference to FIG. 9, an example of a configuration of a terminal apparatus 200 according to the second example embodiment is described. FIG. 9 is a block diagram illustrating an example of a schematic configuration of the terminal apparatus 200 according to the second example embodiment. With reference to FIG. 9, the terminal apparatus 200 includes a receive processing unit 241 and an execution unit 243. Concrete operations of the receive processing unit 241 and the execution unit 243 will be described later.

The receive processing unit 241 and the execution unit 243 may be implemented by the same processor or may be implemented individually by different processors. The receive processing unit 241 and the execution unit 243 may include a memory storing programs (instructions) and one or more processors that can execute the programs (instructions), and the one or more processors may perform operations of the receive processing unit 241 and the execution unit 243. The programs may be programs for causing the processor(s) to perform operations of the receive processing unit 241 and the execution unit 243.

### 4.3. Technical Features

Next, technical features of the second example embodiment are described.

In the second example embodiment, the base station 100 (acquisition unit 151) acquires an identifier used to newly establish, in a state where plurality of services are provided by using a first radio bearer, a second radio bearer for at least one first service among the plurality of services. The base station 100 (transmit processing unit 153) then transmits the identifier to the terminal apparatus 200.

For example, the acquisition unit 151 may perform the operation of the acquisition unit 141 according to the above-described first example embodiment. Moreover, the transmit processing unit 153 may perform the operation of the transmit processing unit 143 according to the above-described first example embodiment.

Moreover, the terminal apparatus 200 (receive processing unit 241) receives the identifier from the base station 100. The terminal apparatus 200 (execution unit 243) then executes processing relating to the first service, by using the identifier.

For example, the receive processing unit 241 may perform the operation of the receive processing unit 233 according to the above-described first example embodiment. Moreover, the execution unit 243 may perform the operation of the execution unit 235 according to the above-described first example embodiment.

The second example embodiment has been described above. According to the second example embodiment, it is possible, for example, to ensure, in an environment where plurality of services are provided to a terminal apparatus through a radio communication network, stable communication of the radio communication network with respect to a certain service.

### 5. Other Modes

The example embodiments of the present invention have been described above. However, the present invention is not limited to these example embodiments. It should be understood by those skilled in the art that these example embodiments are merely provided as examples and that various modifications can be made without departing from the scope and spirit of the present invention.

For example, the steps in any processing described herein need not be performed chronologically in the order illustrated in the corresponding sequence diagram. For example, the steps of the processing may be performed in a different order from the order illustrated as the corresponding sequence diagram or may be performed in parallel. In addition, one or some of the steps of the processing may be deleted, or one or more steps may be added to the processing.

Moreover, an apparatus including constituent elements (e.g., the acquisition unit, the transmit processing unit, the receive processing unit, and/or the scheduling processing unit) of the base station described herein (e.g., one or more apparatuses (or units) of the plurality of apparatuses (or units) configuring the base station or a module for one of the plurality of apparatuses (or units)) may be provided. An apparatus including constituent elements (e.g., the transmit processing unit, the receive processing unit, and/or the execution unit) of any terminal apparatus described herein (e.g., a module for a terminal apparatus) may be provided. In addition, a method including processing of the constituent elements may be provided, and a program (or program product) for causing a processor to execute processing of the constituent elements may be provided. Furthermore, a non-transitory computer readable medium (non-transitory computer readable recording medium) recording the program may be provided. It is apparent that such an apparatus, a module, a method, a program, and a non-transitory computer readable medium are also included in the present invention.

Some of or all the above-described example embodiments can be described as in the following Supplementary Notes, but are not limited to the following.

### (Supplementary Note 1)

A base station comprising:

an acquisition unit configured to acquire an identifier used to newly establish, in a state where plurality of services are provided by using a first radio bearer, a second radio bearer for at least one first service among the plurality of services; and

a transmit processing unit configured to transmit the identifier to a terminal apparatus.

### (Supplementary Note 2)

The base station according to Supplementary Note 1, wherein the first service is a mission critical service.

### (Supplementary Note 3)

The base station according to Supplementary Note 1 or 2, wherein the acquisition unit acquires the identifier by configuring the identifier, based on identification information for identifying the terminal apparatus using the first service.

### (Supplementary Note 4)

The base station according to Supplementary Note 3, wherein the identification information is notified by a server managing the first service.

### (Supplementary Note 5)

The base station according to Supplementary Note 4, wherein the identification information is notified in a case that the server determines to be impossible to maintain operation of the first service.

### (Supplementary Note 6)

The base station according to Supplementary Note 4, wherein the identification information is notified by the server at the time of starting operation of the first service.

### (Supplementary Note 7)

The base station according to any one of Supplementary Notes 4 to 6, wherein the server is a mobile edge computing (MEC) server.

### (Supplementary Note 8)

The base station according to any one of Supplementary Notes 1 to 7, wherein the identifier is a radio network temporary identifier (RNTI).

### (Supplementary Note 9)

The base station according to any one of Supplementary Notes 1 to 8, wherein the transmit processing unit transmits, to the terminal apparatus, the identifier and control information relating to header compression for a packet for the first service.

### (Supplementary Note 10)

The base station according to any one of Supplementary Notes 1 to 9, further including a scheduling processing unit configured to perform scheduling relating to the second radio bearer, based on control information relating to header compression for a packet for the first service.

### (Supplementary Note 11)

A terminal apparatus comprising:

a receive processing unit configured to receive, from a base station, an identifier used to newly establish, in a state where plurality of services are provided by using a first radio bearer, a second radio bearer for at least one first service among the plurality of services; and

an execution unit configured to execute processing relating to the first service, by using the identifier.

### (Supplementary Note 12)

A method including:

acquiring an identifier used to newly establish, in a state where plurality of services are provided by using a first radio bearer, a second radio bearer for at least one first service among the plurality of services; and

transmitting the identifier to a terminal apparatus.

### (Supplementary Note 13)

A method including:

receiving, from a base station, an identifier used to newly establish, in a state where plurality of services are provided by a first radio bearer, a second radio bearer for at least one first service among the plurality of services; and

executing processing relating to the first service, by using the identifier.

### (Supplementary Note 14)

A program causing a processor to execute:

acquiring an identifier used to newly establish, in a state where plurality of services are provided by using a first radio bearer, a second radio bearer for at least one first service among the plurality of services; and

transmitting the identifier to a terminal apparatus.

### (Supplementary Note 15)

A program causing a processor to execute:

receiving, from a base station, an identifier used to newly establish, in a state where plurality of services are provided by using a first radio bearer, a second radio bearer for at least one first service among the plurality of services; and

executing processing relating to the first service, by using the identifier.

### (Supplementary Note 16)

A computer-readable non-transitory recording medium recording a program causing a processor to execute:

acquiring an identifier used to newly establish, in a state where plurality of services are provided by using a first radio bearer, a second radio bearer for at least one first service among the plurality of services; and

transmitting the identifier to a terminal apparatus.

### (Supplementary Note 17)

A computer-readable non-transitory recording medium recording a program causing a processor to execute:

receiving, from a base station, an identifier used to newly establish, in a state where plurality of services are provided by using a first radio bearer, a second radio bearer for at least one first service among the plurality of services; and

executing processing relating to the first service, by using the identifier.

It is possible to ensure, in an environment where plurality of services are provided to a terminal apparatus through a radio communication network, stability of communication of the radio communication network with respect to a certain service.

What is claimed is:

1. A base station comprising:
a memory storing a program; and
one or more processors configured to execute the program to:
acquire an identifier used to newly establish, in a state where plurality of services are provided by using a first radio bearer, a second radio bearer for at least one first service among the plurality of services; and
transmit the identifier to a terminal apparatus.

2. The base station according to claim 1, wherein the first service is a mission critical service.

3. The base station according to claim 1, wherein the one or more processors configured to execute the program to acquire the identifier by configuring the identifier, based on identification information for identifying the terminal apparatus using the first service.

4. The base station according to claim 3, wherein the identification information is notified by a server managing the first service.

5. The base station according to claim 4, wherein the identification information is notified in a case that the server determines to be impossible to maintain operation of the first service.

6. The base station according to claim 4, wherein the identification information is notified by the server at time of starting operation of the first service.

7. The base station according to claim 4, wherein the server is a mobile edge computing (MEC) server.

8. The base station according to claim 1, wherein the identifier is a radio network temporary identifier (RNTI).

9. The base station according to claim 1, wherein the one or more processors configured to execute the program to transmit, to the terminal apparatus, the identifier and control information relating to header compression for a packet for the first service.

10. The base station according to claim 1, the one or more processors configured to execute the program to perform scheduling relating to the second radio bearer, based on control information relating to header compression for a packet for the first service.

11. A terminal apparatus comprising:
a memory storing a program; and
one or more processors configured to execute the program to:
receive, from a base station, an identifier used to newly establish, in a state where plurality of services are provided by using a first radio bearer, a second radio bearer for at least one first service among the plurality of services; and
execute processing relating to the first service, by using the identifier.

12. A method including:
acquiring an identifier used to newly establish, in a state where plurality of services are provided by using a first radio bearer, a second radio bearer for at least one first service among the plurality of services; and
transmitting the identifier to a terminal apparatus.
